(19) United States
(12) Patent Application Publication
(10) Pub. No.: US 2015/0087744 A1
(43) Pub. Date: Mar. 26, 2015

(54) ANTISTATIC RUBBER COMPOUND AND ANTISTATIC TIRE

(71) Applicant: Lembaga Getah Malaysia, Kuala Lumpur (MY)

(72) Inventors: Kok Chong Yong, Sungai Buloh, Selangor Darul, Ehsan (MY); Ahmad Kifli Che Aziz, Sungai Buloh, Selangor Darul, Ehsan (MY)

(73) Assignee: Lembaga Getah Malaysia, Kuala Lumpur (MY)

(21) Appl. No.: 14/386,853

(22) PCT Filed: Mar. 22, 2013
(86) PCT No.: PCT/MY2013/000059

§ 371 Date: Sep. 22, 2014

(30) Foreign Application Priority Data
Mar. 22, 2012 (MY) PI 2012001307

(51) Int. Cl. C08K 13/02

(52) U.S. Cl. CPC C08K 13/02
USPC 523/156; 523/155

(57) ABSTRACT

A rubber compound for the manufacture of antistatic tires used in vehicles comprising a rubber component derived from epoxidized natural rubber, a white filler component for reducing rolling resistance of said tire, an electrically conductive filler component, and a vulcanization agent. An antistatic tire for vehicles comprising a body and a tread wherein said tread is produced from said rubber compound above.

There are several methods of providing this conductive pathway. U.S. Pat. No. 6,523,585 teaches using an electrically conductive rubber compound for the tire treads. The US patent teach of electrically conductive rubber compound tires made from blending different synthetic rubbers, non-chemically modified natural rubber, white filler and different types of electrically conductive filler, e.g. carbon black and metallic salts. White filler acts to reduce the rolling resistance of the tire tread. However, since white fillers are natural electrical insulators, this will result in a reduction of the antistatic properties of the tire. In order to counter this, a high proportion of electrically conductive filler was added which resulted in increased rolling resistance of the tire produced and higher production costs.

Another option is to introduce electrically conductive elements into the tires as a pathway to dissipate electrostatic charges. Conductive elements such as metallic staples (U.S. Pat. No. 6,220,319), conductive rubber strips (U.S. Pat. No. 5,937,926), terminal parts (U.S. Pat. No. 6,269,854), filamentary threads (U.S. Pat. No. 6,289,958) and metallic or carbon fibre based cords (U.S. Pat. No. 7,284,583) have been used to provide a pathway to dissipate electrostatic charges. These conductive elements attached to the non-conductive tire tread are usually rigid and non-elastomeric. This will affect the physical properties of the non-conductive rubber tire tread and also the performance of the tire itself such as its elasticity, rolling resistance and performance in wet conditions.

Hence, there is a need for an antistatic tire for dissipating accumulated electrostatic charges from a vehicle that exhibits a high level of antistatic property without compromising on physical properties that will affect the performance of the tire. This invention thus aims to alleviate some or all of the problems of the prior art.

### SUMMARY OF THE INVENTION

In an aspect of the invention, there is provided a rubber compound for the manufacture of antistatic tires used in vehicles comprising a rubber component derived from epoxidized natural rubber (ENR), a white filler component for reducing rolling resistance of the tire, an electrically conductive filler component and a vulcanization agent.

In an embodiment, the ENR may comprise solid form ENR of a grade containing about 20.0 to about 75.0 mole % of epoxide content and preferably about 25.0 to about 50.0 mole % of epoxide content.

In another embodiment, the white filler component may comprise silica wherein the silica may be crystalline silica or amorphous silica.

In a further embodiment, the electrically conductive filler component may comprise carbon black wherein the carbon black may be selected from a group consisting of reinforcing grade-carbon black, semi-reinforcing grade-carbon black and/or conductive grade-carbon black.

In another embodiment of the present invention, the rubber compound may comprise about 50.0 to about 100.0 parts per hundred rubber (p.p.h.r.) of ENR; about 5.0 to about 60.0 p.p.h.r. of silica; about 10.0 to about 60.0 p.p.h.r. of electrically conductive carbon black; and about 0.1 to about 4.0 p.p.h.r. of sulfur vulcanization agent. The rubber compound preferably contains about 100.0 p.p.h.r. or epoxidized natural rubber, about 25.0 p.p.h.r. of silica, about 35.0 p.p.h.r. of electrically conductive carbon black and about 1.25 p.p.h.r. of the vulcanization agent.

In a further embodiment, the rubber compound may further comprise vulcanization accelerators wherein the vulcanization accelerator may be selected from a group consisting of guanidine, sulphonamide, thiazole, thiuram, dithiocarbamate or xanthate. The compound may contain between 0 to about 6.0 p.p.h.r. and preferably about 1.5 p.p.h.r. of vulcanization accelerators.

In another embodiment of the present invention, the rubber compound may also further comprise vulcanization activators wherein the vulcanization activator may be selected from a group consisting of zinc oxide, stearic acid or the direct form of zinc stearate. The compound may contain between 0 to about 8.0 p.p.h.r. and preferably about 6.0 p.p.h.r. of vulcanization activators.

In another embodiment of the present invention, the rubber compound may comprise antioxidants wherein the antioxidant may be thiol, amine or hydroquinone antioxidants. The compound may contain between 0 to about 5.0 p.p.h.r. and preferably about 2.0 p.p.h.r. of antioxidants.

In a further embodiment, the rubber compound may further comprise aromatic, paraffinic and/or naphthenic processing oils. The compound may contain between 0 to about 10.0 p.p.h.r. and preferably about 5.0 p.p.h.r. of processing oils.

In another embodiment, the rubber compound may further comprise metallic stearate release agents. The compound may contain between 0 to about 5.0 p.p.h.r. and preferably about 2.0 p.p.h.r. of release agents.

In a second aspect of the present invention, there is provided an antistatic tire for vehicles comprising a body and a tread wherein the tread is produced from the rubber compound of the present invention.

Further, there is provided a method for producing the rubber compound of the present invention. The method comprises the following steps:
i) providing an appropriate amount of ENR;
ii) mixing the ENR with a white filler component and an electrically conductive filler component to produce a masterbatch;
iii) adding a vulcanization agent to the masterbatch of step (ii); and
iv) heating the masterbatch to vulcanize the compound.

The mixing device used in the above method may be an internal mechanical mixing device and/or an open milling device.

It is an aim of the present invention to provide a rubber compound for the manufacture of antistatic tires that is suitable especially, though not exclusively, for use in commercial vehicles.

The rubber compound and antistatic tire of this invention provides for various advantages which will be further elaborated in the following pages.

### BRIEF DESCRIPTION OF THE DRAWINGS

The invention is illustrated, although not limited, by the following description of embodiments made with reference to the accompanying drawings in which:

FIG. 1 illustrates the basic chemical structure of the smallest repeat unit of an epoxidized natural rubber molecule;

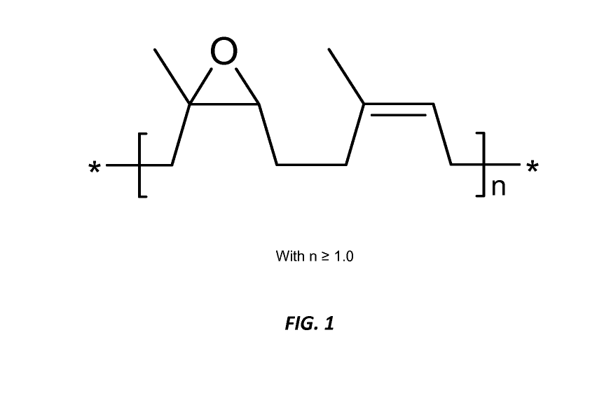

FIG. 2 illustrates the general 2-dimensional anatomical view of the main structures for an internal mechanical mixing device.

FIG. 3 illustrates the general 2-dimensional anatomical view of the main structures for an open milling device.

### DETAILED DESCRIPTION OF THE EMBODIMENTS

The present invention is directed to a rubber compound for the manufacture of antistatic tires for use in vehicles, methods for producing the rubber compound and the antistatic tire produced from the rubber compound.

### Rubber Compound

The rubber compound mainly comprises a rubber component, a white filler component, an electrically conductive filler component and a vulcanization agent.

The rubber component is derived from ENR, a type of chemically modified natural rubber harvested from the Hevea Braziliensis tree which is manufactured by reacting the harvested natural rubber with peroxy formic acid. ENR conveys several desirable properties such as good dispersion level of fillers, good tensile properties, improved oxidation resistance, reduced gas permeability and an enhanced abrasion resistance to the tires produced from it. The ENR compound based tire of this invention have been observed to exhibit lower rolling resistance and better traction in wet conditions compared to tires made of non-modified natural rubber. Additionally, not only does the ENR compound based tire provide for a better tire performance, it is also an environmentally friendly tire option (which is considered green technology). This is because ENR compound based tires exhibit better performance over natural rubber tires which will lead to lower fuel consumption.

Any suitable form of ENR may be used as the rubber host. Solid form-epoxidized natural rubber of any grade between 20.0 to 75.0 mole % of epoxide content is preferred. ENR of 25.0 to 50.0 mole % of epoxide content is particularly preferred. The ENR may comprise 50.0 to 100.00 parts per hundred rubber (p.p.h.r.), preferably 100.00 p.p.h.r., of the rubber compound.

For the white filler component, any suitable filler that reduces the rolling resistance of the tire may be used. Preferably, the white filler component used is silica, either crystalline or amorphous silica which may be used independently or in combination. When silica is used, 5.0 to 60.0 p.p.h.r., preferably 25.0 p.p.h.r., of silica is added to the ENR.

However, white filler is a highly insulating material that is known to reduce the antistatic properties of a rubber compound. In order to increase the antistatic properties of the compound, a sufficient amount of a suitable electrically conductive filler component is added. Any suitable electrically conductive component may be used. Preferably, the electrically conductive filler component used is carbon black. The carbon black used may be selected from a group consisting of reinforcing grade-carbon black, semi-reinforcing grade-carbon black and/or conductive grade-carbon black. The carbon black may be added in an amount of 10.0 to 60.0 p.p.h.r., and preferably 35.0 p.p.h.r. By adding this component, the resulting rubber compound's electrical resistance is lowered. This will allow the entire tire tread made from the rubber compound of this invention to act as a high efficient electrical pathway to dissipate any electrostatic charge accumulated.

Any suitable vulcanization agent may be used for vulcanization of the rubber compound of this invention. Preferably, the rubber mixture is vulcanized by adding sulfur to the mixture at an amount of 0.1 to 4.0 p.p.h.r., and preferably 1.25 p.p.h.r. Heat is applied to the mixture by any known technique, preferably by way of a hot press or microwave irradiation to activate the vulcanization process.

The rubber compound may further comprise additional vulcanization components such as vulcanization accelerators and vulcanization activators.

Any suitable vulcanization accelerators may be used. The vulcanization accelerators used may be selected from a group consisting of guanidine, sulphonamide, thiazole, thiuram, dithiocarbamate or xanthate which may be used independently or in any combination thereof. These accelerators may be added in an amount of 0 to 6.0 p.p.h.r., and preferably 1.50 p.p.h.r.

Any suitable vulcanization activators may be used. The vulcanization activators used may be selected from a group consisting of zinc oxide, stearic acid or the direct form of zinc stearate which may be used independently or in any combination thereof. The activators may be added in an amount of 0 to 8.0 p.p.h.r., and preferably 6.0 p.p.h.r.

The vulcanization activators are preferably added to the compound before the vulcanization process. The vulcanization agent and vulcanization accelerators are added later in order to avoid any premature vulcanization of the rubber compound which may cause hardening and result in reduced processability of the compound.

The compound may also be selectively mixed with further components such as antioxidants, processing oils, and release agents.

Any suitable antioxidant that enhances the rubber compound's oxidation resistance may be used. The antioxidant used may comprise thiol, amine or hydroquinone antioxidants which may be used independently or in any combination thereof. The antioxidants may be added in an amount of 0 to 5.0 p.p.h.r., and preferably 2.0 p.p.h.r.

Any suitable processing oil that acts as a processing aid to enhance the processability of the compound by improving the dispersion of fillers and flow characteristics of the compound may be used. The processing oil may comprise aromatic, paraffinic and/or naphthenic processing oils which may be used independently or in any combination. The processing oils may be added in an amount of 0 to 10.0 p.p.h.r., and preferably 5.0 p.p.h.r.

Any suitable release agent which acts to reduce the tackiness of the rubber compound before the vulcanization process and also aids in removing the vulcanized rubber compound from its mould after vulcanization may be used. The release agent preferably comprises types of metallic stearate. The release agents may be added in an amount of 0 to 5.0 p.p.h.r., and preferably 2.0 p.p.h.r.

Method of Producing Antistatic Tire

Two types of mixing devices are used in the method for producing the rubber compound of this invention. The first mixing device used is an internal mechanical mixing device, a general rubber or polymer processing device. The device includes some of the main structures in a closed system. The internal mechanical mixing device comprises:
i) a top portion where a vertically oscillating ram 1 controls the input of raw materials through a hopper 2;
ii) a body where a generally spherical shaped mixing chamber 3 is located, with a pair of rotating rotors 4 (with controllable rotating speed) positioned in the mixing chamber 3;
iii) a heating system 5 is installed within the walls of the mixing chamber to control the mixing chamber's temperature; and
iv) a discharge door 6 where the finished material is discharged at the bottom of the mixing chamber.

The size of the device used is variable and is dependent on the amount of material desired to be processed.

The second mixing device is an open milling device. An open milling device is a general rubber processing device, which includes a main structure and mainly comprises:
i) a pair of horizontally disposed counter-rotating rollers 7 with a variable gap distance 8 between the rollers in an open system where raw material is fed at the top of the rollers and falls between the rollers. The distance (nip) between the rollers is controlled by a nip adjusting mechanism 9 which is a set of gears that moves the pair of rollers towards or away from each other;
ii) a heating system 10 installed within the body of the rotating rollers to control the surface temperature of the rollers; and
iii) a mill tray 11 located below the pair of rollers where the finish material is discharged from the rollers and collected.

The size of the device used is variable and is dependent on the amount of material desired to be processed.

The method for producing the rubber compound of the present invention mainly comprises the following steps:
i) providing an appropriate amount of ENR;
ii) mixing the ENR with a white filler component and an electrically conductive filler component to produce a masterbatch;
iii) adding a vulcanization agent to the masterbatch of step (ii); and
iv) heating the masterbatch to vulcanize the compound.

Vulcanization activators, antioxidants, release agents and/or processing oils may be selectively added in step (ii).

The mixing of step (ii) may be conducted in an internal mechanical mixing device with the following parameters:
i) temperatures ranging from about 60.0 to about 180.0° C., and preferably about 70.0 to about 130° C.;
ii) fill factors about 0.50 to about 0.95, and preferably about 0.70; and
iii) rotor turning speed of about 20 to about 120 revolutions per minute (rpm), and preferably about 100 rpm.

Alternatively, an open milling device may be used for step (ii) at an operating temperature ranging from about 23.0 to about 80.0° C., and preferably about 50° C.

The vulcanization agent and vulcanization accelerators are added in step (iii) to the ENR-based masterbatch. The process of step (iii) is conducted at a temperature ranging from about 23.0 to about 80.0° C., and preferably about 50.0° C., to avoid premature vulcanization that may cause hardening and also reduce the processability of the compound.

The vulcanization process in step (iv) is conducted at a temperature ranging from about 120 to about 180° C., and preferably about 150° C., where heat is applied by any known technique, preferably by way of a heat press or microwave irradiation.

### Antistatic Tire

Advantageously, the antistatic tire produced from the rubber compound of the present invention does not contain any rigid, non-elastomeric elements that may compromise on certain physical properties of the compound which will affect the performance of the tire.

The antistatic tire does not contain any synthetic rubber compound of any form. Using only one type of rubber, i.e. ENR, simplifies the process of manufacturing the tire compared to conventional tires that uses a blend of synthetic and natural rubbers. ENR also exhibits better chemical interactions with the white filler component which improves the reinforcement effect of the compound. Antistatic tires using only ENR without any synthetic rubber compounds exhibit reduced heat build-up and rolling resistance which leads to better fuel consumption.

The antistatic tire produced from the rubber compound of the present invention has been observed to exhibit very low electrical volume resistance of 10¹ to 10⁹ ohms and good non-aged physical properties i.e. tensile strengths of 16.0 to 29.0 MPa, elongation of 350.0 to 700.0%, with a modulus at 300% elongation and 10.0 to 19.0 MPa, and International Rubber Hardness Degrees (IRHD) of 50.0 to 95.0.

The aged rubber compound of the antistatic tire retains 90 to 98% of its tensile strength, 85 to 95% of elongation value and 1 to 5 degrees of IRHD increment after being accelerated at 70° C. for 168 hours.

### EXAMPLE

The following Examples illustrate the various aspects, methods and steps of the process of this invention. These Examples do not limit the invention, the scope of which is set out in the appended claims.

### Example 1

### Formulations of Sulfur-Vulcanized Epoxidized Natural Rubber Based Compound for Commercial Vehicle's Antistatic Tire Tread Manufacturing Purpose

A sulfur-vulcanized epoxidized natural rubber based compound of this invention with various compositions of electrically conductive filler and white filler were produced in order to measure its physical properties and also electrical resistance. Selected examples of formulation for preparing the vulcanized epoxidized natural rubber based compound are shown in Table 1.

TABLE 1
Formulations of Sulfur-Vulcanized Epoxidized Natural Rubber based Compound

| | Part per hundred rubber [p.p.h.r.] | | | | | | |
|---|---|---|---|---|---|---|---|
| Raw material/ | Blend | Blend | Blend | Blend | Blend | Blend | Blend |
| chemical | 1 | 2 | 3 | 4 | 5 | 6 | 7 |
| ENR 25 | 100.0 | 100.0 | 100.0 | 100.0 | 100.0 | 100.0 | 100.0 |
| Carbon black-XC 72 | 10.0 | 10.0 | 15.0 | 15.0 | 15.0 | 15.0 | 20.0 |
| Carbon black-N330 | 45.0 | 35.0 | 20.0 | 15.0 | 5.0 | 0.0 | 0.0 |
| Silica-Zeosil 1165MP | 5.0 | 15.0 | 25.0 | 30.0 | 40.0 | 50.0 | 50.0 |
| Oil-Nytex 4700 | 5.0 | 5.0 | 5.0 | 5.0 | 5.0 | 5.0 | 5.0 |
| Antioxidant-Santoflex 6PPD | 1.0 | 1.0 | 1.0 | 1.0 | 1.0 | 1.0 | 1.0 |
| Antioxidant-Flectol TMQ | 1.0 | 1.0 | 1.0 | 1.0 | 1.0 | 1.0 | 1.0 |
| Accelerator-Santocure TBBS | 1.25 | 1.25 | 1.25 | 1.25 | 1.25 | 1.25 | 1.25 |
| Accelerator-Perkacit TBzTD | 0.25 | 0.25 | 0.25 | 0.25 | 0.25 | 0.25 | 0.25 |
| Calcium stearate | 2.0 | 2.0 | 2.0 | 2.0 | 2.0 | 2.0 | 2.0 |
| Zinc oxide | 3.0 | 3.0 | 3.0 | 3.0 | 3.0 | 3.0 | 3.0 |
| Stearic acid | 3.0 | 3.0 | 3.0 | 3.0 | 3.0 | 3.0 | 3.0 |
| Sulfur | 1.25 | 1.25 | 1.25 | 1.25 | 1.25 | 1.25 | 1.25 |

100.0 p.p.h.r. of solid epoxidized natural rubber (i.e. ENR 25 grade with 25.0±3.0 mole % of epoxide contents, manufactured by the Malaysian Rubber Board) was used as the rubber host.

10.0 to 20.0 p.p.h.r. of carbon black XC 72 (conductive grade, manufactured by Cabot Corporation) and 5.0 to 45.0 p.p.h.r. of carbon black N330 (reinforcing grade, manufactured by Cabot Corporation) were added as the electrically conductive filler component.

5.0 to 50.0 p.p.h.r. of silica Zeosil 1165MP (amorphous grade) was added as the white filler component.

1.25 p.p.h.r. of sulfur was added as the vulcanizing agent. 1.25 p.p.h.r. of Santocure TBBS (N-t-butyl-2-benzothiazole sulfenamide) and 0.25 p.p.h.r. of Perkacit TBzTD (tetrabenzylthiuram disulfide) were added as the vulcanization accelerator. Both 3.0 p.p.h.r. of zinc oxide and 3.0 p.p.h.r. of stearic acid were added as the vulcanization activator.

1.0 p.p.h.r. of Santoflex 6PPD [N-(1,3-dimethylbutyl)-N′-phenyl-P-phenylenediamine] and 1.0 p.p.h.r. of Flectol TMQ (2,2,4-trimethyl-1,2-dihydroquinoline) were added as the antioxidants.

2.0 p.p.h.r. of calcium stearate was added as the release agent.

5.0 p.p.h.r. of processing oil (grade Nytex 4700, type napthenic) was added as a processing aid in order to enhance the processability of the compound.

The above example illustrates different formulations that may be used to produce the rubber compound of the present invention.

### Example 2

### Preparation of a Sulfur-Vulcanization System Containing Epoxidized Natural Rubber Based Compound of Example 1 by Using a Combination of an Internal Mechanical Mixing Device and an Open Milling Device

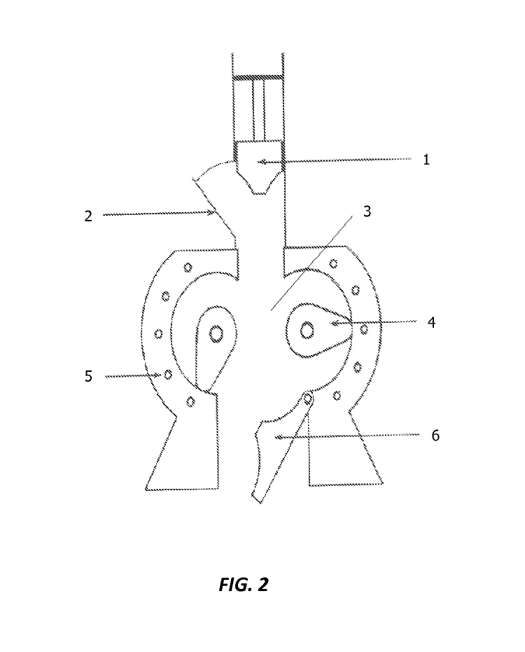

At the first stage of mixing, epoxidized natural rubber based masterbatches with different proportions of electrical conductive filler and white filler (according to the formulation as shown in Table 1 of Example 1) were prepared by using an internal mechanical mixing device as illustrated by FIG. 2. A fill factor of 0.70 (from the total free volume of an internal mixing device's mixing chamber) was used to conduct the process. The starting temperature for each mixing was 70° C. and the rotor turning speed was 100 rpm. Each stage of the mixing process is described in Table 2:

TABLE 2
Stages of Preparation of Epoxidized Natural Rubber based
Masterbatch by using the an Internal Mechanical Mixing Device
for Steps (i) and (ii) and an Open Milling Device for Step (iii)

| Stage of mixing | Timing |
|---|---|
| 1. Addition of epoxidized natural rubber | 0^{th} minute |
| 2. Addition of electrically conductive filler, | 2^{nd} minute |
| white filler, processing oils, antioxidants, | |
| release agents and vulcanization | |
| activators to produce masterbatch | |
| 3. Discharge of masterbatch | 7^{th} minute |
| | (Total time = |
| | 7 minutes) |

Sulfur and vulcanization accelerators (according to Table 1 of Example 1) were added to each of the epoxidized natural rubber based masterbatches by using a two-roll open milling device (at temperatures of 50° C.) at the second stage of mixing. Each of the sulfur-vulcanization system produced containing epoxidized natural rubber based compound was then removed from the two-roll open milling device after a total mixing time of 6 minutes.

The above example illustrates the process flow using the first method as described with the process conditions used clearly indicated. The example also shows the total time taken from step (i) to (iii).

### Example 3

### Epoxidized Natural Rubber Based Compound Prepared by a Sulfur-Vulcanization System Using an Open Milling Device

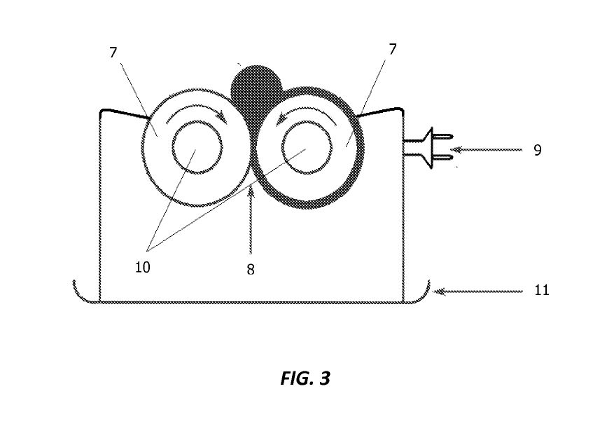

Epoxidized natural rubber based compound with different proportions of electrically conductive filler and white filler (accordingly to the formulation as shown in Table 1 of Example 1) were prepared directly by using a two-roll open milling device as illustrated in FIG. 3. The starting temperature for each batch was 30° C. Each stage of the mixing process is described in Table 3:

TABLE 3
Stages of Preparation of Epoxidized Natural Rubber based
Compound by using the Open Milling Device

| Stages of mixing | Timing |
|---|---|
| Stage 1: | |
| 1. Addition of epoxidized natural rubber | 0^{th} minute |
| 2. Addition of electrically conductive filler, | 2^{nd} minute |
| white filler, processing oils, antioxidants, | |
| release agents and vulcanization activators | |
| to produce masterbatch | |
| Stage 2: | |
| 3. Addition of sulfur and vulcanization | 15^{th} minute |
| accelerators | |
| 4. Discharge of blend | 20^{th} minute |
| | (Total time = |
| | 20 minutes) |

Each of the sulfur-vulcanization system containing epoxidized natural rubber based compounds was then removed from the two-roll open milling device after 20 minutes of total mixing period.

The above example illustrates the process flow using the second method as described with the process conditions used clearly indicated. The example also shows the total time taken from step (i) to (iii) using an open milling device.

### Example 4

### Preparation of Vulcanized Samples for Measurement of Physical Properties Test and Electrical Volume Resistances

Each of the sulfur-vulcanization system containing epoxidized natural rubber based compounds was prepared according to Examples 1, 2 and 3. Appropriate amounts (varied according to the type of target test) of each sulfur-vulcanization system containing epoxidized natural rubber based compound were weighed and fed into a mould (dimension of the mould is also varied according to the type of target test). The mould together with the sulfur-vulcanization system containing epoxidized natural rubber based compound were vulcanized by using an electrical hot press machine with heating temperature of 150° C., at a pressure of 413.68 kPa (60 psi) and for a duration based on the T_{c90} (curing time to at least 90% of curing level) of each blend (as measured by a Monsanto's moving die-rheometer). The T_{c90} values of all compounds prepared by using the first method and second method are summarized in Tables 4 and 5 respectively.

TABLE 4
T_{c90} of Sulfur-Vulcanization System Containing Epoxidized Natural
Rubber based Compounds prepared by using The First Method according
to Examples 1 and 2 (Cured at Temperature, 150° C.)

| Epoxidized Natural Rubber | |
|---|---|
| based Compound | T_{c90} (minute) |
| Blend 1 | 4.55 |
| Blend 2 | 5.43 |
| Blend 3 | 6.72 |
| Blend 4 | 7.18 |
| Blend 5 | 7.33 |
| Blend 6 | 7.57 |
| Blend 7 | 7.71 |

TABLE 5
T_{c90} of Sulfur-Vulcanization System Containing Epoxidized Natural
Rubber based Compounds prepared by using The Second Method
according to Examples 1 and 3 (Cured at Temperature, 150° ^{C.})

| Epoxidized Natural Rubber | |
|---|---|
| based Compound | T_{c90} (minute) |
| Blend 1 | 4.83 |
| Blend 2 | 5.78 |
| Blend 3 | 6.98 |
| Blend 4 | 7.35 |
| Blend 5 | 7.54 |
| Blend 6 | 7.73 |
| Blend 7 | 7.95 |

The above example illustrates step 4 of the first and second method as described in Examples 1 through 3. The tables illustrate the time taken to produce the vulcanized rubber of up to 90% curing level for different blends as described in Table 1 of Example 1. From the tables above, it is clear that Blend 1 shows the fastest curing time.

### Example 5

### Electrical and Physical Properties of the Sulfur-Vulcanized Epoxidized Natural Rubber Based Compounds

Test samples of sulfur-vulcanized epoxidized natural rubber based compounds prepared accordingly to Examples 1 to 4 showed electrical volume resistance values (as measured by using the 2-probe technique with a Keithley 6157A Electrometer) in the magnitude orders of 10⁹ ohms or less (refer to Tables 6 and 7).

TABLE 6
Magnitude Orders of Electrical Volume Resistance Values (Ohms) for
Test Samples of Sulfur-Vulcanized Epoxidized Natural Rubber based
Compounds prepared by using The First Method according to
Examples 1, 2 and 4

| | Magnitude Order of |
|---|---|
| Epoxidized Natural Rubber | Electrical Volume Resistance |
| based Compound | (Ohm) |
| Blend 1 | ×10³ |
| Blend 2 | ×10³ |
| Blend 3 | ×10⁴ |
| Blend 4 | ×10⁴ |
| Blend 5 | ×10⁸ |
| Blend 6 | ×10⁸ |
| Blend 7 | ×10⁷ |

TABLE 7
Magnitude Orders of Electrical Volume Resistance Values (Ohms) for
Test Samples of Sulfur-Vulcanized Epoxidized Natural Rubber based
Compounds prepared by using The Second Method according
to Examples 1, 3 and 4

| | Magnitude Order of |
|---|---|
| Epoxidized Natural Rubber | Electrical Volume |
| based Compound | Resistance (Ohm) |
| Blend 1 | ×10³ |
| Blend 2 | ×10³ |
| Blend 3 | ×10⁴ |
| Blend 4 | ×10⁴ |
| Blend 5 | ×10⁸ |
| Blend 6 | ×10⁸ |
| Blend 7 | ×10⁷ |

Test samples of sulfur-vulcanized epoxidized natural rubber based compounds prepared accordingly to Examples 1 to 4 exhibited International Rubber Hardness Degrees [IRHD] values (as measured accordingly to the Malaysian Standard, MS ISO 48) as shown in Tables 8 and 9.

TABLE 8
International Rubber Hardness Degrees [IRHD] Values of
Sulfur-Vulcanized Epoxidized Natural Rubber based Compounds
prepared by using the First Method according to Examples 1, 2 and 4

| | IRHD (Degree) | |
|---|---|---|
| Epoxidized Natural Rubber | | Aged Value |
| based Compound | Non-Aged Value | (168 hr at 70° ^{C.}) |
| Blend 1 | 71 | 73 |
| Blend 2 | 70 | 72 |
| Blend 3 | 70 | 71 |
| Blend 4 | 71 | 72 |
| Blend 5 | 75 | 76 |
| Blend 6 | 84 | 84 |
| Blend 7 | 86 | 87 |

TABLE 9
International Rubber Hardness Degrees [IRHD] Values of
Sulfur-Vulcanized Epoxidized Natural Rubber based Compounds
prepared by using the Second Method according to Examples 1, 3 and 4

| | IRHD (Degree) | |
|---|---|---|
| Epoxidized Natural Rubber | | Aged Value |
| based Compound | Non-Aged Value | (168 hr at 70° ^{C.}) |
| Blend 1 | 73 | 75 |
| Blend 2 | 72 | 73 |
| Blend 3 | 73 | 74 |
| Blend 4 | 74 | 75 |
| Blend 5 | 78 | 79 |
| Blend 6 | 87 | 87 |
| Blend 7 | 89 | 90 |

Test samples of sulfur-vulcanized epoxidized natural rubber based compounds prepared accordingly to Examples 1 to 4 showed some tensile properties values (measured accordingly to the Malaysian Standard, MS ISO 37) as summarized in Tables 10 to 15.

TABLE 10
Tensile Strength Values of Sulfur-Vulcanized Epoxidized Natural
Rubber based Compounds prepared by using the First Method
according to Examples 1, 2 and 4

| | Tensile Strength (MPa) | |
|---|---|---|
| Epoxidized Natural Rubber | | Aged Value |
| based Compound | Non-Aged Value | (168 hr at 70° ^{C.}) |
| Blend 1 | 25.1 | 22.7 |
| Blend 2 | 26.1 | 24.5 |
| Blend 3 | 24.6 | 23.8 |
| Blend 4 | 23.9 | 22.4 |
| Blend 5 | 23.0 | 20.7 |
| Blend 6 | 23.2 | 22.2 |
| Blend 7 | 23.7 | 22.6 |

TABLE 11
Elongation at Break Percentage [EB %] Values of Sulfur-Vulcanized
Epoxidized Natural Rubber based Compounds prepared by using the
First Method according to Examples 1, 2 and 4

| | EB % | |
|---|---|---|
| Epoxidized Natural Rubber | | Aged Value |
| based Compound | Non-Aged Value | (168 hr at 70° ^{C.}) |
| Blend 1 | 582 | 497 |
| Blend 2 | 613 | 562 |
| Blend 3 | 559 | 487 |
| Blend 4 | 521 | 473 |
| Blend 5 | 423 | 386 |
| Blend 6 | 415 | 362 |
| Blend 7 | 494 | 426 |

TABLE 12
Modulus at 300% Elongation [M300] Values of Sulfur-Vulcanized
Epoxidized Natural Rubber based Compounds prepared by using
the First Method according to Examples 1, 2 and 4

| | M300 (MPa) | |
|---|---|---|
| Epoxidized Natural Rubber | | Aged Value |
| based Compound | Non-Aged Value | (168 hr at 70° ^{C.}) |
| Blend 1 | 14.0 | 13.2 |
| Blend 2 | 14.8 | 13.1 |
| Blend 3 | 13.7 | 12.9 |
| Blend 4 | 17.1 | 15.9 |
| Blend 5 | 12.3 | 11.8 |
| Blend 6 | 13.9 | 12.1 |
| Blend 7 | 14.1 | 12.5 |

TABLE 13
Tensile Strength Values of Sulfur-Vulcanized Epoxidized Natural
Rubber based Compounds prepared by using the Second Method
according to Examples 1, 3 and 4

| | Tensile Strength (MPa) | |
|---|---|---|
| Epoxidized Natural Rubber | | Aged Value |
| based Compound | Non-Aged Value | (168 hr at 70° ^{C.}) |
| Blend 1 | 24.4 | 22.4 |
| Blend 2 | 25.6 | 24.1 |
| Blend 3 | 24.3 | 23.5 |
| Blend 4 | 23.2 | 22.6 |
| Blend 5 | 22.8 | 20.9 |
| Blend 6 | 23.0 | 21.9 |
| Blend 7 | 23.5 | 22.1 |

TABLE 14
Elongation at Break Percentage [EB %] Values of Sulfur-Vulcanized
Epoxidized Natural Rubber based Compounds prepared by using the
Second Method according to Examples 1, 3 and 4

| | EB % | |
|---|---|---|
| Epoxidized Natural Rubber | | Aged Value |
| based Compound | Non-Aged Value | (168 hr at 70° ^{C.}) |
| Blend 1 | 570 | 488 |
| Blend 2 | 602 | 554 |
| Blend 3 | 554 | 490 |
| Blend 4 | 513 | 465 |
| Blend 5 | 418 | 372 |
| Blend 6 | 403 | 348 |
| Blend 7 | 487 | 419 |

TABLE 15
Modulus at 300% Elongation [M300] Values of Sulfur-Vulcanized
Epoxidized Natural Rubber based Compounds prepared by using the
Second Method according to Examples 1, 3 and 4

| | M300 (MPa) | |
|---|---|---|
| Epoxidized Natural Rubber | | Aged Value |
| based Compound | Non-Aged Value | (168 hr at 70° ^{C.}) |
| Blend 1 | 13.8 | 13.0 |
| Blend 2 | 14.6 | 13.7 |
| Blend 3 | 13.3 | 12.5 |
| Blend 4 | 16.5 | 14.5 |
| Blend 5 | 12.1 | 11.2 |
| Blend 6 | 13.7 | 11.8 |
| Blend 7 | 14.3 | 12.7 |

The above example illustrates the electrical and physical properties of each blend manufactured according to Examples 1 to 4. From the results, it is apparent that the rubber compound of Blend 1 and Blend 2 has the lowest electrical volume resistance value. IRHD values, however, show that Blend 2 and 3 has the lowest value after ageing as compared to Blend 1.

In the tensile strength tests for the rubber compound produced according to the first and second method, Blend 2 shows has the highest tensile strength value before and after ageing of the compound. Elongation tests similarly show that Blend 2 has the highest EB % at before and after ageing of the compound manufactured.

In conclusion, Blend 2 shows the most desirable properties as compared to the other blends manufactured according to the method of the present invention.

As will be readily apparent to those skilled in the art, the present invention may easily be produced in other specific forms without departing from its scope.

### FIELD OF INVENTION

This invention generally relates to rubber compounds. More particularly the invention relates to a rubber compound for the manufacture of antistatic tires used in vehicles, the method for producing the rubber compound and the antistatic tire made from the rubber compound.

### BACKGROUND ART

A tire is generally a circular-shaped covering that wraps around the rims of the wheels of a vehicle and provides a flexible surface that acts as a cushion that absorbs shock when the vehicle is in motion. Tires are usually made of synthetic rubber, natural rubber, fabric and wire, along with other compounds and chemical additives. The tire consists of a tread and a body, with the tread portion providing traction to the surface it is in contact with while the body provides support. The majority of tires today are inflatable structures where the tire is filled with compressed air to form an inflatable cushion.

A major problem that vehicles face is the build up of electrostatic charges. Electrostatic build up occurs when the tire treads roll along a surface creating friction, which causes electrostatic build up on the surface of the tires. Electrostatic build up may also occur due to the rotation and movements of mechanical parts in the vehicle. If these accumulated electrostatic charges are not dissipated from the vehicle, interference may occur with electronic circuits within the vehicle such as the radio or satellite navigation devices. Further electrostatic build up may pose a safety hazard especially to highly flammable materials stored in the vehicle fuel tank. This hazard is even more apparent in commercial vehicles transporting highly flammable goods.

An ideal pathway to dissipate accumulated electrostatic charges on the vehicle is through the tires since the tires are the only part of the vehicle in direct contact with the ground. A method to dissipate electrostatic charge through tires is by using antistatic tires. An antistatic tire provides at least one electrically conductive pathway from the vehicle to the ground.

1. A rubber compound for the manufacture of antistatic tires used in vehicles comprising
a rubber component derived from epoxidized natural rubber;
a white filler component for reducing rolling resistance of said tire;
a vulcanization agent, and
a conductive grade carbon black component.

2. A rubber compound according to claim 1, wherein said epoxidized natural rubber (ENR) comprises solid form ENR of a grade containing about 20.0 to about 75.0 mole % of epoxide content.

3. A rubber compound according to claim 1, wherein said epoxidized natural rubber (ENR) comprises solid form ENR of a grade containing about 25.0 to about 50.0 mole % of epoxide content.

4. A rubber compound according to claim 1, wherein said white filler component comprises silica.

5. A rubber compound according to claim 4, wherein said silica is crystalline silica.

6. A rubber compound according to claim 4, wherein said silica is amorphous silica.

7. A rubber compound according to claim 1, wherein said conductive grade carbon black comprises XC 72 grade carbon black.

8. A rubber compound according to claim 1, wherein said rubber compound further comprises at least one of reinforcing grade-carbon black and semi-reinforcing grade-carbon black.

9. A rubber compound according to claim 1, wherein said compound comprises
about 50.0 to about 100.0 p.p.h.r. of epoxidized natural rubber;
about 5.0 to about 60.0 p.p.h.r. of silica;
about 10.0 to about 60.0 p.p.h.r. of conductive grade carbon black; and
about 0.1 to about 4.0 p.p.h.r. of sulfur vulcanization agent.

10. A rubber compound according to claim 9, wherein said compound contains about 100 p.p.h.r. of epoxidized natural rubber.

11. A rubber compound according to claim 9, wherein said compound contains about 25.0 p.p.h.r. of silica.

12. A rubber compound according to claim 9, wherein said compound contains about 35.0 p.p.h.r. of electrically conductive carbon black.

13. A rubber compound according to claim 9, wherein said compound contains about 1.25 p.p.h.r. of said vulcanization agent.

14. A rubber compound according to claim 1, wherein said compound further comprises vulcanization accelerators.

15. A rubber compound according to claim 14, wherein said vulcanization accelerators is selected from a group consisting of guanidine, sulphonamide, thiazole, thiuram, dithiocarbamate or xanthate.

16. A rubber compound according to claim 14, wherein said compound contain between 0 to about 6.0 p.p.h.r. and preferably about 1.5 p.p.h.r. of vulcanization accelerator.

17. A rubber compound according to claim 1, wherein said compound further comprises vulcanization activators.

18. A rubber compound according to claim 17, wherein said vulcanization activators is selected from a group consisting of zinc oxide, stearic acid or the direct form of zinc stearate.

19. A rubber compound according to claim 17, wherein said compound contain between 0 to about 8.0 p.p.h.r. and preferably about 6.0 p.p.h.r. of vulcanization activators.

20. A rubber compound according to claim 1, wherein said compound further comprises antioxidants.

21. A rubber compound according to claim 20, wherein said antioxidants is selected from a group consisting of thiol, amine or hydroquinone antioxidants.

22. A rubber compound according to claim 20, wherein said antistatic tire contain up to about 5.0 p.p.h.r. of antioxidants.

23. A rubber compound according to claim 1, wherein said compound further comprises aromatic, paraffinic and/or naphthenic processing oils to enhance processability of the compound.

24. A rubber compound according to claim 23, wherein said compound contain up to about 10.0 p.p.h.r. of processing oils.

25. A rubber compound according to claim 1, wherein said compound comprise types of metallic stearate release agents to reduce tackiness of the rubber compound.

26. A rubber compound according to claim 25, wherein said compound contain up to about 5.0 p.p.h.r. of release agents.

27. An antistatic tire for vehicles comprising
a body; and
a tread, said tread produced from the rubber compound according to claim 1.
